(19) United States
(12) Patent Application Publication
(10) Pub. No.: US 2026/0154949 A1
(43) Pub. Date: Jun. 4, 2026

(54) RELIABILITY PREDICTION METHOD FOR IMAGE CLASSIFICATION NEURAL NETWORK MODEL

(71) Applicant: BEIJING AEROSPACE INSTITUTE FOR METROLOGY AND MEASUREMENT TECHNOLOGY, Beijing (CN)

(72) Inventors: Yifei LIU, Beijing (CN); Yinxiao MIAO, Beijing (CN); Jing SUN, Beijing (CN); Long ZHANG, Beijing (CN); Zhonghao CHENG, Beijing (CN); Xiujian ZHANG, Beijing (CN)

(21) Appl. No.: 19/258,771

(22) Filed: Jul. 2, 2025

(30) Foreign Application Priority Data
Nov. 27, 2024 (CN) 202411710009.1

(51) Int. Cl. G06V 10/776; G06V 10/764; G06V 10/766; G06V 10/774; G06V 10/82

(52) U.S. Cl. CPC G06V 10/776; G06V 10/764; G06V 10/774; G06V 10/82; G06V 10/766

(57) ABSTRACT

A reliability prediction method for an image classification neural network model includes: a reliability model is trained; and the trained reliability model predicts a reliability of the image classification neural network model. According to training and testing of the image classification neural network model, input features of the reliability model include a model training factor and a model testing factor. The model training factor characterizes data and model factors affecting the reliability of the image classification neural network model. The model testing factor characterizes a test sufficiency of the image classification neural network model. An output of the reliability model is a reliability prediction result of the image classification neural network model.

### CROSS-REFERENCE TO RELATED APPLICATIONS

This application claims the benefit of priority from Chinese Patent Application No. 202411710009.1, filed on Nov. 27, 2024. The content of the aforementioned application, including any intervening amendments thereto, is incorporated herein by reference in its entirety.

### TECHNICAL FIELD

This application relates to computer software testing, and more particularly to a reliability prediction method of a neural network model.

### BACKGROUND

Neural networks, as a leading machine learning technology, play a crucial role in contemporary technological and industrial applications. Neural network technology continues to expand its own capabilities, tackling a wide range of complex problems—from image processing to identity authentication, automatic driving, medical diagnosis, and financial analysis. Thus, neural network technology has gradually become the core technology of the current intelligent software.

Moreover, neural networks also have increasingly prominent challenges in safety and reliability. For example, for automatic driving cars, a minor algorithmic error or data deviation may lead to serious safety accidents. In medical diagnosis, an inaccurate prediction of a model may have an irreversible impact on the patient's health. Therefore, improving the reliability of neural networks is not only a requirement to enhance system performance, but also a necessity to ensure safety and protect lives. Reliability modeling of neural network models is essential to ensure the robustness and reliability of intelligent software systems in the real world.

At present, research on intelligent software reliability is insufficient, while studies on traditional software reliability primarily rely on statistics and probability theory. Classical models include time-based or fault data-based models such as Non-homogeneous Poisson process (NHPP) model, which focus on predicting future performance of the software through historical fault data. These classical models usually assume deterministic and consistent statistical properties of software behavior, which exhibit limitations while dealing with complex and dynamic system environments. In addition, neural networks, as the core of intelligent software, have a different programming paradigm from traditional software. The structure and operation mechanism of neural networks are more complex than traditional software. The behavior of neural network models is affected by various factors such as training data and model structure. Reliability prediction models only on time or fault data are too simple to meet the reliability prediction requirements of neural network models in terms of prediction accuracy and adaptability.

Reliability modeling of neural networks faces many challenges, partly due to the complexity of their internal structure. A typical deep learning model may contain millions of parameters and multiple layers of nonlinear transformations, which makes it exceptionally difficult to analyze its behavior. Moreover, the training process of neural networks is also highly dynamic and unpredictable, relying on initial conditions and randomness. These properties make it difficult to apply traditional reliability modeling methods to neural networks, as these modeling methods usually assume the behavior of the system has some degree of statistical regularity or repeatability and can be predicted based on time. However, for neural networks, each prediction is independent of each other and will not accumulate faults over time, resulting in the fact that traditional time-based prediction techniques are no longer applicable.

### SUMMARY

In view of the deficiencies in the prior art, this application provides a reliability prediction method for image classification neural network model by analyzing reliability influencing factors of neural networks and combining chaos theory of traditional software reliability and machine learning technology that can extract implied features.

Technical solutions of this application are described as follows.

This application provides a reliability prediction method for an image classification neural network model, comprising:
training a reliability model; and
predicting, by the trained reliability model, a reliability of the image classification neural network model;
wherein according to training and testing of the image classification neural network model, input features of the reliability model comprise a model training factor and a model testing factor; the model training factor is provided for characterizing training data and model factors affecting the reliability of the image classification neural network model; the model testing factor is provided for characterizing a test adequacy of the image classification neural network model; and an output of the reliability model is a reliability prediction result of the image classification neural network model.

In an embodiment, the model training factor comprises a training data quality factor and a model performance factor; the training data quality factor comprises a training dataset size and a training data distinguishability; the training dataset size reflects a sufficiency of training data; the training data distinguishability reflects a complexity of a target task; the model performance factor comprises the number of model parameters, a model training loss, and the number of training iterations; the number of model parameters reflects a complexity of a model structure; the model training loss reflects a model training effect; and the number of training iterations determines a depth and degree of a model learning from the training data.

In an embodiment, the training data distinguishability is calculated based on Linear relaxation based perturbation analysis (LiRPA).

In an embodiment, the training data distinguishability is calculated through steps of:
corresponding each sample in a training dataset to a correct class, and calculating a confidence interval for each sample classified under perturbation to each possible class by LiRPA; and the sample refers to input data in the training process;
calculating a probability of misclassification of each sample to other possible classes; wherein a probability that a sample is misclassified from a correct class a to an incorrect class b is equal to: Intersection of Union (IoU) of a first confidence interval corresponding to the correct class a and a second confidence interval corresponding to the incorrect class b is divided by 2;
calculating and averaging probabilities of misclassification of samples corresponding to the correct class a to the other possible classes, which is denoted as a confusion degree of data of the correct class a; and
averaging confusion degrees of data of all classes to get a confusion degree of the training dataset which is the training data distinguishability.

In an embodiment, the model training loss is an average of losses of samples in a training dataset.

In an embodiment, the model testing factor is characterized by a testing degree factor; the testing degree factor comprises the number of testing iterations, a testing dataset size, and a model structure coverage; the number of testing iterations reflects a model testing depth; the testing dataset size reflects a testing cost; and the model structure coverage is a test adequacy characterization metric based on neuron activation.

In an embodiment, neuron coverage is provided as a metric of the model structure coverage.

In an embodiment, the reliability model adopts support vector regression (SVR).

In an embodiment, the step of “training the reliability model” comprises:
preparing a training dataset, a testing dataset, and a neural network model set;
training neural network models in the neural network model set on the training dataset to obtain the model training factor; and
testing the neural network models in the neural network model set on the testing dataset to obtain the model testing factor;
wherein eight reliability influencing factor metric values formed by the model training factor and the model testing factor constitute explanatory variables of the reliability model; a dependent variable is an accuracy of the neural network model on a corresponding dataset; and the reliability model is trained to establish a relationship between the explanatory variables and the dependent variable.

In an embodiment, the step of “predicting, by the trained reliability model, a reliability of the image classification neural network model” comprises preparing the model training factor and the model testing factor of the neural network model to be predicted.

Compared to reliability prediction techniques of existing software, this application has the following beneficial effects.
1. This application solves the lack of reliability prediction methods, the difficulty of modeling reliability influencing factors, and the difficulty of measuring the security and reliability levels for current neural network models. According to the characteristics of the neural network model, this application deconstructs and analyzes the influencing factors and key parameters of the reliability, and constructs a reliability prediction method based on SVR for the neural network model, which can effectively improve the accuracy, generalization, and fault tolerance of the reliability prediction of the neural network model.
2. The modeling factors of the reliability model include model performance, data quality, and testing degree. The running data of the neural network model is used as the training data of the SVR model, thereby obtaining the reliability prediction results of the neural network model more dynamically and intuitively.
3. Model training factors are used to characterize the training data and model factors affecting the reliability of neural networks, model testing factors are used to characterize the test adequacy, and the two kinds of factors can characterize the reliability of the model comprehensively.
4. The size of the dataset profoundly impacts the neural network training, influencing multiple aspects including the model performance, the generalization ability, the training speed and the final application scopes. To understand how the data volume affects the training results is the key to optimizing the deep learning projects. When the dataset size is large enough and the samples are more widely distributed, the model has more opportunities to learn the nuances and complex structures in the data, thereby making more accurate predictions and classifications. Dataset distinguishability greatly determines the performance and reliability of the neural network.
5. The reliability of neural networks can be more finely and systematically modeled by combining the multiple tests including the number of testing iterations and the model structure coverage. The number of testing iterations and the size of the testing dataset directly reflect the testing depth and the testing cost of the model. The model structure coverage provides a more granular assessment of testing thoroughness from the model internal architecture. Usually, the higher the degree of testing, the higher the reliability of the tested model.
6. This application can effectively support the development of intelligent software.

### BRIEF DESCRIPTION OF THE DRAWINGS

FIG. 1 is a flowchart of a reliability prediction process for a neural network model according to an embodiment of the present disclosure;

FIG. 2 is a schematic diagram of reliability influencing factors of the neural network model according to an embodiment of the present disclosure; and

FIG. 3 shows a reliability prediction framework of the neural network model according to an embodiment of the present disclosure.

### DETAILED DESCRIPTION OF EMBODIMENTS

The disclosure will be further described in detail in conjunction with the following embodiments and the accompanying drawings, which are not intended to limit the disclosure.

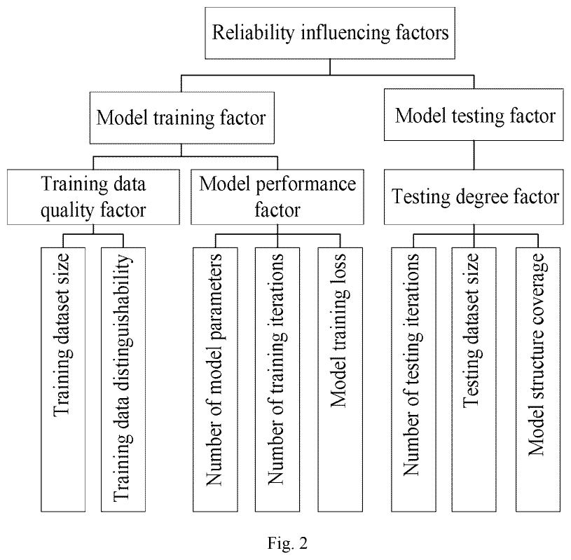

The present disclosure establishes a reliability prediction model applicable to a neural network from factors affecting the reliability of the neural network. As shown in FIG. 2, according to two aspects of training and testing of the neural network model, the influencing factors are categorized into a model training factor and a model testing factor. The model training factor includes a training data quality factor and a model performance factor, and the model testing factor includes a testing degree factor.

Specifically, the training data quality factor includes a training dataset size and a training data distinguishability, which reflect the sufficiency of training data and the complexity of the target task, respectively.

The model performance factor includes the number of model parameters, a model training loss, and the number of training iterations. The number of model parameters and the model training loss reflect the complexity of the model structure and the training effect, respectively. The number of model parameters is a direct metric to measure the potential of the model. Models with more parameters usually have stronger data fitting ability and theoretically can capture more complex data features, but may bring the risk of overfitting. The model training loss is an important metric for evaluating the training effect, which is directly related to the reliability and accuracy of the model in practical applications. The lower the training loss, the better the model performs on the training set, but too low a loss may mean overfitting. The basic purpose of the loss function is to quantify the difference between the model output and the actual label. By continuously optimizing this difference during training, the model gradually learns how to accurately predict or classify.

The testing degree factor includes the number of test iterations, the testing dataset size, and the model structure coverage.

In the reliability model training, the training data size, the number of training iterations, the number of model parameters (determined by the model structure), the testing dataset size, the number of testing iterations can be directly set.

In the reliability model training, it is necessary to provide the neural network model and the dataset that meets the set conditions.

In reliability model training, the training data distinguishability, the model training loss, and the model structure coverage can be derived from the neural network modeling process and output data.

In the reliability prediction, the training data size, the number of training iterations, the number of testing iterations, the tested model, the testing dataset needs to be provided by the tested party.

In the reliability prediction, the number of the model parameters and the testing dataset size can be obtained directly from the tested model and the testing dataset.

In the reliability prediction, the training data distinguishability, the model training loss, and the model structure coverage can be derived from the neural network modeling process and the output data.

The number of training iterations in the model has a significant impact on the model reliability. The number of training iterations determines the depth and degree of the model learning from the data. When the number of training iterations is too low, the model may fail to adequately learn features from the data, resulting in underfitting, which shows poor performance on both the training and testing set, and an inability to accurately predict new data. On the contrary, too many training iterations may lead to overfitting, that is, the model overlearns the noise and details in the training data and performs erratically on the testing set or new data, affecting the generalization ability. Therefore, it is crucial to choose an appropriate number of training iterations, which balances the learning depth of the model in the training data and the predictive ability on new data, so as to ensure the reliability of the model.

The number of testing iterations, as a direct metric, can reflect the testing depth of the model and the cost of testing, and can be used for preliminary modeling of test adequacy.

Training data distinguishability is calculated as follows. The dataset distinguishability is performed based on Linear relaxation based perturbation analysis (LiRPA). LiRPA is an advanced technique aimed at evaluating and enhancing the ability of the neural networks to differentiate different classes of inputs. The dataset differentiability is evaluated by the network's ability to maintain the correct output when subjected to small input changes. The similarity between two categories is analyzed by gradually adding perturbation strengths and observing the change in the confidence interval predicted by the model at this time, and determining the categories to which the data may be misdirected. By analyzing the overlapping intervals of two categories, the distance relationship between any two categories is obtained and eventually averaged to obtain the total dataset distinguishability.

In neural networks, the output of each neuron is a nonlinear function of the input. The core of the LiRPA method is to approximate the behavior of these nonlinear functions with linear upper and lower bounds, so as to calculate the response bounds of the output neurons within a given input perturbation range. This calculation of response bounds of the output neurons is performed by constructing a calculation graph including all network layers, and the linear response of each layer is derived based on the output of the previous layer. To achieve this, LiRPA utilizes a range of algorithms, such as automatic differentiation and interval propagation, to automate this process, thereby avoiding the tedious process of manually deriving the response of each layer.

The calculation graph is defined as a directed acyclic graph which is expressed as G=(V, E). V={1, 2, . . . , n} is the set of neurons in the calculation graph, and E is the set of neuron pairs. A neuron i is an input of a neuron j. For the sake of simplification, the indegree of the neuron i is denoted as m(i), and the set of input neurons is expressed as u(i)={u₁(i), . . . , uₘ₍ᵢ₎(i)}, where each pair (uⱼ(i), i) belong to E, and 1≤j≤m(i).

Each neuron i has several key properties: Hᵢ(⋅) represents the corresponding calculation function, and hᵢ=Hᵢ(u(i)) is the vector generated by the neuron i. Although hᵢ may be a tensor in practice, for simplicity in this disclosure, it is assumed that hᵢ has been flattened into a vector.

Each neuron i is either an independent neuron, indegree m (i)=0, representing an input neuron to the graph (e.g., a network parameter or a model input), or a dependent neuron, representing preforming some computation (e.g., ReLU).

For independent neurons, Hᵢ(⋅) is an identity function; hᵢ=xᵢ is denoted for neural networks, where xᵢ denotes the input data. For dependent neurons, X represents the set of all xᵢ such that the output of each neuron i can be expressed as a function of X, namely, hᵢ=Hᵢ(X), without explicitly referencing uⱼ(i). Without loss of generality, the calculation graph is assumed to have a single output neuron o.

For perturbation analysis, regarding neural network, xᵢ can be chosen arbitrarily from its input space [symbol] . If xᵢ unperturbed, [symbol] =[cᵢ], where cᵢ is a constant vector. For a neural network, [symbol] is defined as the space of X, where each part xᵢ of X is perturbed in its input space [symbol] .

In the LiRPA, the goal is to compute provable lower and upper bounds on the values of the output neurons hₒ=Hₒ(X), namely, when the lower bound hₒ and the upper bound h̅ₒ̅ at the element level are perturbed within [symbol] , hₒ≤Hₒ(X)≤h̅ₒ̅, which is true for all X∈ [symbol] . In LiRPA, for neural networks, tight lower and upper bounds are obtained by first calculating linear bounds of X: WₒX+bₒ≤Hₒ(X)≤W̅ₒ̅X+b̅ₒ̅∀X∈S, where hₒ(X) is defined by the linear function of X and the parameters W̅ₒ̅, b̅ₒ̅, Wₒ, bₒ.
For neural networks, the existing LiRPA methods are divided into the forward mode perturbation analysis and the backward mode perturbation analysis. The two methods aim to obtain bounds in different ways.

In the forward mode, LiRPA propagates the linear bounds of each neuron with respect to all independent neurons, i.e., linear bounds of X, to subsequent neurons all the way to the output neuron o.

In the backward mode, LiRPA propagates the linear bounds of the output neuron o with respect to the dependent neurons to the precursor neurons until all independent neurons are reached.

The forward mode LiRPA on the general calculation graph computes the linear bounds of Hᵢ(X) with respect to all independent neurons for each neuron i in the graph and neural networks: WᵢX+bᵢ≤Hᵢ(X)≤W̅ᵢ̅X+b̅ᵢ̅∀X∈ [symbol] .

For the neural network, it starts with independent neurons. For one independent neuron i, for the neural network, there is hᵢ=Hᵢ(X)=xᵢ, so for the neural network, the bounds Iₓ_{ᵢ}≤hᵢ≤Iₓ_{ⱼ} can be clearly obtained. For one dependent neuron i, for the neural network, there is one forward LiRPA prediction function Gᵢ. The function Gᵢ accepts wᵢ, bᵢ, w̅ᵢ̅, b̅ᵢ̅ of each jϵu(i) as input and generates new linear bounds for the neuron i. Assuming that all the neurons jϵu(i) have been defined, so (Wᵢ, bᵢ, W̅ᵢ̅, b̅ᵢ̅)=Gᵢ((Bⱼ|jϵu(i))), where Bⱼ:=(Wᵢ, bᵢ, W̅ᵢ̅, b̅ᵢ̅).

The backward model LiRPA on the general calculation graph:

For each neuron, two properties Aᵢ And A̅ᵢ̅ are maintained and represent the coefficients in the linear bounds of Hₒ(X) with respect to Hᵢ(X):

$$\sum \text{?} ( X ) + \underline{d} \leq H \text{?} ( X ) \leq \sum \text{?} \overline{{A}_{i}} {H}_{i} ( X ) + \overline{d} , ∀ X ∈ 𝕊 .$$

$$\text{?} \text{indicates text missing or illegible when filed}$$

d and d̅ are bias terms in the neural network algorithm. If the output dimension of the neuron i is sᵢ, and the dimension of the output neuron o is sₒ, then the matrices Aᵢ and A̅ᵢ̅ have the shape of sₒ×sᵢ. Then, there are Aₒ=Āₒ=I, Aᵢ=Āᵢ=0(i≠o), d=d̅=0 which makes the previous equation workable.

When the neuron i is a dependent neuron, there is the backward LiRPA prediction function Fᵢ, which is designed to compute the lower bound AᵢHᵢ(X) and the upper bound A̅ᵢ̅Hᵢ(X), and these bounds are represented by linear functions of its predecessor neurons u₁(i), u₂(i), . . . , uₘ₍ᵢ₎(i), where (Λᵤ_{₁}₍ᵢ₎, Λ̅ᵤ_{₁}₍ᵢ₎, Λᵤ_{₂}₍ᵢ₎, Λ̅ᵤ_{₂}₍ᵢ₎, . . . , Λᵤ_{ₘ₍ᵢ₎}₍ᵢ₎, Λ̅ᵤ_{ₘ₍ᵢ₎}₍ᵢ₎, Δ, Δ̅)=Fᵢ(Aᵢ, A̅ᵢ̅),

$$s . t . {\sum }_{j ∈ u ( i )} {\underline{Λ}}_{j} {H}_{j} ( X ) + \underline{Δ} \leq \underline{{A}_{i}} {H}_{i} ( X ) , \overline{{A}_{i}} {H}_{i} ( X ) \leq {\sum }_{i ∈ V} {\underline{Λ}}_{j} {H}_{j} ( X ) + \overline{Δ} .$$

For neural networks, the term Hᵢ(X) in formula is replaced with the above new bounds, so that these terms are backpropagated and replaced by the terms associated with Hⱼ(X)(j∈u(i) in the formula.

Eventually, all terms are propagated to the independent neurons, and Hₒ(X) will be defined only by the linear functions of the independent neurons.

Based on the above derivation process, a sample (with original label a) can be solved by LiRPA to find a confidence interval classified into each possible class (a, b, c, d) under certain perturbations. Intersection of Union (IoU) of the confidence interval of the correct class a and the confidence interval of the incorrect class b is divided by 2 to obtain the probability of misclassification to the class b. In the same way, the probability of misclassification to the class c and the class d can be calculated, respectively. By calculating the probability of misclassification of all the samples with original labels a, and then averaging them separately, the whole misclassification probability of the samples a to the classes b, c, and d can be obtained. The probability of misclassification of the sample originally labeled a to the classes b, c, d is averaged to obtain the confusion degree of data of the class a. In the same way, the confusion degrees of the data of the classes b, c, and d are obtained, respectively. The confusion degrees of data of the classes a, b, c and d are averaged to obtain the confusion degree of the whole test dataset. The smaller the confusion degree, the more distinguishable the dataset.

Specifically, by LiRPA, confidence intervals can be obtained for each data to be predicted into each class under a particular perturbation. For example, for one CIFAR10 image whose original class may be dog, its predicted confidence interval will fluctuate under certain perturbations. The intersection of the confidence interval for a dog and the confidence interval for a cat is 0.4-0.6, and their union set is 0.2-0.9, and at this time Intersection of Union is 2/7, which represents the probability that the confidence level falls into the intersection in the case of cats or dogs, and the probability that the classification is both correct and incorrect is ½. Therefore, the probability that the image originally labeled as a dog is misclassified as a cat is 2/7*½= 1/7. By combining all images and classes, the overall misclassification probability of the dataset can be finally obtained, and the closer the value is to 0, the greater the distinguishability is.

The model training loss can estimate the degree of inconsistency between the predicted value of the model and the true value, and is related to the loss function set by the model, which can be directly output by the model. The training set used to obtain the training loss can extract a part of the dataset of the initial training model. Computationally, the training loss is calculated by averaging the losses for each sample in the training set.

The model structure coverage is the metric for characterizing test adequacy based on neuron activation, for example, neuron coverage, neuron boundary coverage, and neuron density coverage are proposed in the disclosure. In this disclosure, neuron coverage is used as a metric of the model structure coverage. The activation threshold is set to 0.75, and if the neuron activation value is greater than the threshold, the neuron is covered, and the ratio of the coverage to the total number of neurons is calculated as the metric of the model structure coverage.

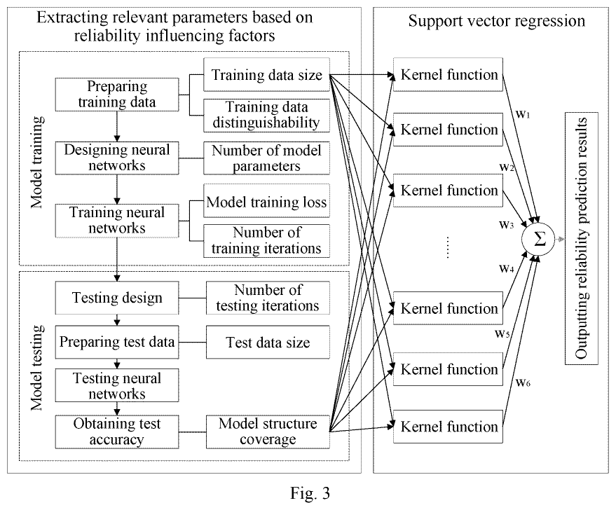

The reliability model uses the support vector regression (SVR) method to implement chaotic modeling of the reliability of the neural network model. Specifically, the input of the reliability model is the aforementioned model training factor and model testing factor. The output of the reliability model is the task accuracy of the neural network model, i.e., the reliability of the neural network model. In the complex environment of practical development, the interaction of multiple factors often presents a complex nonlinear relationship. The kernel function is introduced to achieve linear separability after high-dimensional mapping, thereby solving the problem of nonlinear regression analysis. Regularization parameters are set to achieve the balance between the model complexity and the training error, thereby improving the accuracy, generalization and fault tolerance of the reliability prediction of the neural network model. The reliability prediction framework diagram is shown in FIG. 3. The following is a common-sense description of support vector regression.

Support vector regression, also known as function estimation, aims to find an optimal function from a given sample dataset that accurately reflects the relationship between the sample data. Considering the training set T={(x₁, y₁), (x₂, y₂), . . . , (xᵢ, yᵢ)} of dataset, where

$${x}_{i}^{a} ∈ {R}^{n} ,$$

(a=1, 4, . . . , 8) is a vector of eight explanatory variable values (influencing factor metric values), and yᵢ∈R is the corresponding dependent variable value. The goal of this disclosure is to find an optimal functional relationship to fit these data points. In the support vector machine model, the function f(x) is defined as a linear form, i.e. ƒ(x)=w·x+b, where w denotes the weight vector, and b is the bias term. Assuming that support vector regression allows for a maximum error of ϵ between ƒ(x) and y, and the loss is calculated only when the absolute value of the difference between ƒ(x) and y is greater than ϵ. Thus, the goal of SVR is as follows:

$${min}_{\{ w , b \}} \frac{1}{2} {‖ w ‖}^{2} + C {\sum }_{i = 1}^{m} {l}_{ϵ} ( f ( {x}_{i} ) - {y}_{i} ) .$$

In the above formula, C is a regularization constant, l_{ϵ} is the loss function. To enhance the prediction ability of the model in the case of small samples, an insensitive loss function with e is introduced to adjust the fitting degree of the model to the data. The insensitive loss function is expressed as:

$${l}_{ϵ} ( f ( x ) , y ) = \{ \begin{matrix}0 , if ⋁ f ( x ) - y ⋁ ϵ \\ \vert f ( x ) - y \vert - ϵ , other\end{matrix}$$

Throughout the training set, the maximum fitting error of all data points does not exceed ϵ, which means that the maximum distance of all input data points to the decision plane defined by the model in the high-dimensional feature space is ϵ.

To solve the dual optimal problem, the optimal regression estimation function is obtained as follows:

$$f ( x ) = \sum \text{?} ( {α}_{i} - {α}_{i}^{*} ) ( {x}_{i} \cdot x ) + b$$

$$s . t . \{ \begin{matrix}{\sum }_{i = 1}^{m} ( {α}_{i} - {α}_{i}^{*} ) = 0 \\ {α}_{i} , {α}_{i}^{*} ∈ [ 0 , C ]\end{matrix}$$

$$b = \frac{1}{N \text{?}} \sum \text{?} [ y \text{?} - \sum \text{?} ( α \text{?} - α \text{?} ) ( x \text{?} \cdot x \text{?} ) ] + \frac{1}{N \text{?}} \sum \text{?} [ {y}_{i} \sum \text{?} ( {α}_{j} - {α}_{j}^{*} ) ( {x}_{j} \cdot {x}_{i} ) + ε ] .$$

$$Where$$

$$\text{?} \text{indicates text missing or illegible when filed}$$

Considering the nonlinearity of the neural network model, the kernel function is introduced, x and xᵢ of the sample space are replaced by the mapped image φ(x) and φ(xᵢ), so that K(xᵢ, x)=(φ(xᵢ)·φ(x)), the regression function is changed as:

$$f ( x ) = ( w \cdot φ ( x ) ) + b = \sum \text{?} ( {a}_{i} - {a}_{i}^{*} ) K ( {x}_{i} , x ) + b ;$$

$$b = \frac{1}{N \text{?}} \{ \sum \text{?} [ {y}_{i} - \sum \text{?} ( {a}_{j} - {a}_{j}^{*} ) K ( {x}_{j} , {x}_{i} ) - ε ] + \sum \text{?} [ {y}_{i} \sum \text{?} ( {a}_{j} - {a}_{j}^{*} ) K ( {x}_{j} , {x}_{i} ) + ε ] \} .$$

$$where$$

$$\text{?} \text{indicates text missing or illegible when filed}$$

In the above formula, N_{NSV} is the number of standard support vectors.

The input x of the reliability model is the aforementioned model training factor and model testing factor. The output y of the reliability model is the accuracy of the model task in the test, which is the recognition accuracy in image recognition and the reliability of the neural network model.

The parameters of the reliability model are obtained through (x, y), and the reliability prediction results are output. In the test of the new neural network model, the reliability model can be modified constantly to make it closer to the real reliability of the neural network model.

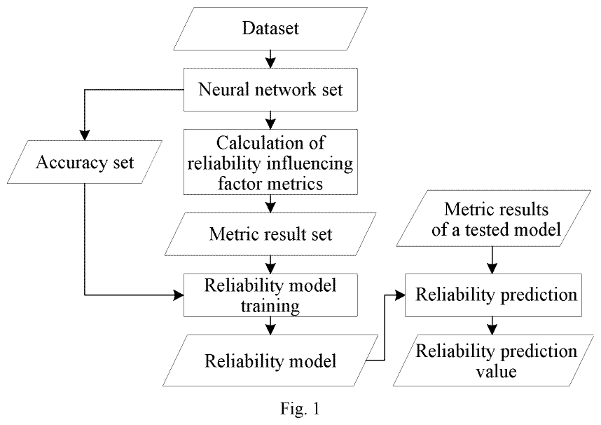

In general, this disclosure first trains the reliability model, and then carries out reliability prediction for the neural network model to be predicted. As described in FIG. 1, the specific process is as follows.

### Step 1 Preparation of Neural Network Set (15 Kinds)

the commonly used open-source neural network models are adopted, including ResNet50, MobileNetV2, GoogLeNet, InceptionNet V2, DenseNet, SqueezeNet, and 9 kinds of simple double hidden layer fully connected networks (the number of hidden layer neurons are [20, 50, 100], [20, 50, 100], and two combinations).

### Step 2 Preparation of Datasets (6 Kinds*10 Sizes)

The dataset contains subdatasets that are sampled from 6 public datasets at different scales. Public datasets are typically divided into training datasets and testing datasets. In the training dataset of public datasets, the size of the training dataset is set to 10%, 20%, 30%, . . . , 100% of the original training set, respectively, and the dataset that meets the size requirements is randomly sampled. Specifically, the public datasets include CIFAR-10, MNIST, ImageNet, SVHN (Street View House Numbers), CIFAR-100, Fashion-MNIST.

### Step 3 Neural Network Model Training

The number of training iterations is randomly selected between 40-300 to construct models with different training effects.

### Step 4 Neural Network Model Testing

The number of testing iterations is set and randomly selected between 40-300, and the size of the testing dataset is selected between 60%-100% of the original testing dataset. The neural network model is tested on the corresponding testing dataset, and the accuracy of each test is collected as the accuracy set, which is used as the dependent variable for SVR model training.

### Step 5 Neural Network Influencing Factor Index Calculation (Calculation of Reliability Influencing Factor)

The training dataset size, the number of training iterations, the number of model parameters (determined by the model structure), the testing dataset size, and the number of testing iterations are extracted, and the training data distinguishability, the model training loss, and the model structural coverage are calculated, thereby obtaining the set of 8 reliability influencing factor metric results (metric result set), which are used as explanatory variables for SVR model training.

### Step 6 Reliability Model Training

Sklearn library is used to train the SVR-based reliability model, in which regarding the parameter settings, e takes the value of 0.01, C takes the value of 10, and the kernel function is RBF kernel function, thereby obtaining the trained reliability model.

### Reliability Prediction

### Step 7

The user provides the neural network model for reliability prediction, the training dataset size, the testing dataset, the number of training iterations, and the number of testing iterations.

### Step 8

Based on the neural network model and the dataset provided by the user, metrics for calculating the neural network influencing factor include the number of model parameters, the testing dataset size, the training data distinguishability, the model training loss, and the model structure coverage.

### Step 9

The eight influencing factor metric values (metric results of the tested model) are input into the trained reliability model, and then the reliability prediction value is output.

What is claimed is:

1. A reliability prediction method for an image classification neural network model, comprising:
training a reliability model; and
predicting, by the trained reliability model, a reliability of the image classification neural network model;
wherein according to training and testing of the image classification neural network model, input features of the reliability model comprise a model training factor and a model testing factor; the model training factor is provided for characterizing training data and model factors affecting the reliability of the image classification neural network model; the model testing factor is provided for characterizing a test adequacy of the image classification neural network model; and an output of the reliability model is a reliability prediction result of the image classification neural network model;
wherein the model training factor comprises a training data quality factor and a model performance factor; the training data quality factor comprises a training dataset size and a training data distinguishability; the training dataset size reflects a sufficiency of training data; the training data distinguishability reflects a complexity of a target task; the model performance factor comprises the number of model parameters, a model training loss, and the number of training iterations; the number of model parameters reflects a complexity of a model structure; the model training loss reflects a model training effect; and the number of training iterations determines a depth and degree of a model learning from the training data; and
the model testing factor is characterized by a testing degree factor; the testing degree factor comprises the number of testing iterations, a testing dataset size, and a model structure coverage; the number of testing iterations reflects a model testing depth; the testing dataset size reflects a testing cost; and the model structure coverage is a test adequacy characterization metric based on neuron activation.

2. The reliability prediction method of claim 1, wherein the training data distinguishability is calculated based on Linear relaxation based perturbation analysis (LiRPA).

3. The reliability prediction method of claim 2, wherein the training data distinguishability is calculated through steps of:
corresponding each sample in a training dataset to a correct class, and calculating a confidence interval for each sample classified under perturbation to each possible class by LiRPA;
calculating a probability of misclassification of each sample to other possible classes; wherein a probability that a sample is misclassified from a correct class a to an incorrect class b is equal to: Intersection of Union (IoU) of a first confidence interval corresponding to the correct class a and a second confidence interval corresponding to the incorrect class b is divided by 2;
calculating and averaging probabilities of misclassification of samples corresponding to the correct class a to the other possible classes, which is denoted as a confusion degree of data of the correct class a; and
averaging confusion degrees of data of all classes to get a confusion degree of the training dataset which is the training data distinguishability.

4. The reliability prediction method of claim 1, wherein the model training loss is an average of losses of samples in a training dataset.

5. The reliability prediction method of claim 4, wherein a neuron coverage is provided as a metric of the model structure coverage.

6. The reliability prediction method of claim 1, wherein the reliability model adopts support vector regression (SVR).

7. The reliability prediction method of claim 1, wherein the step of “training the reliability model” comprises:
preparing a training dataset, a testing dataset, and a neural network model set;
training neural network models in the neural network model set on the training dataset to obtain the model training factor; and
testing the neural network models in the neural network model set on the testing dataset to obtain the model testing factor;
wherein eight reliability influencing factor metric values formed by the model training factor and the model testing factor constitute explanatory variables of the reliability model; a dependent variable is an accuracy of the neural network model on a corresponding dataset; and the reliability model is trained to establish a relationship between the explanatory variables and the dependent variable.

8. The reliability prediction method of claim 1, wherein the step of “predicting, by the trained reliability model, a reliability of the image classification neural network model” comprises: preparing the model training factor and the model testing factor of the neural network model to be predicted.
